(19) United States
(12) Patent Application Publication
(10) Pub. No.: US 2025/0363697 A1
(43) Pub. Date: Nov. 27, 2025

(54) IMAGE GENERATION METHOD AND APPARATUS, ELECTRONIC DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Yuxuan YAN, Shenzhen (CN); Rui WANG, Shenzhen (CN); Pei CHENG, Shenzhen (CN); Bin FU, Shenzhen (CN); Gang YU, Shenzhen (CN)

(21) Appl. No.: 19/292,674

(22) Filed: Aug. 6, 2025

Related U.S. Application Data
(63) Continuation of application No. PCT/CN2023/129860, filed on Nov. 6, 2023.

(30) Foreign Application Priority Data
Jul. 7, 2023 (CN) 202310829833.8

(51) Int. Cl. G06T 11/60; G06V 10/74; G06V 10/77; G06V 10/774; G06V 40/16

(52) U.S. Cl. CPC G06T 11/60; G06V 10/761; G06V 10/7715; G06V 10/774; G06V 40/168

(57) ABSTRACT

Embodiments of this application disclose an image generation method and apparatus, an electronic device, a storage medium, and a program product. The method includes receiving a first source image of a predetermined style and a second source image comprising a predetermined portrait; performing feature extraction on the first source image using at least one image encoder to obtain at least one image feature; performing facial recognition on the second source image using a facial recognition model to obtain a facial feature of the predetermined portrait; concatenating the at least one image feature with the facial feature to obtain a concatenated feature; and inputting the concatenated feature into a trained diffusion model to generate a target image that is in the predetermined style and that comprises the predetermined portrait.

### RELATED APPLICATIONS

This application is a continuation of PCT Application No. PCT/CN2023/129860 filed on Nov. 6, 2023, which in turn claims priority to Chinese Patent Application No. 202310829833.8, entitled “IMAGE GENERATION METHOD AND APPARATUS, ELECTRONIC DEVICE, AND STORAGE MEDIUM” filed with the China National Intellectual Property Administration on Jul. 7, 2023. The two applications are both incorporated by reference in their entirety.

### FIELD OF THE TECHNOLOGY

This application relates to the technical field of image processing, and in particular, to an image generation method and apparatus, an electronic device, a storage medium, and a program product.

### BACKGROUND OF THE DISCLOSURE

With the development of science and technology and diversification of entertainment life, simply watching an image or a video has gradually failed to meet the entertainment requirements. Many times, users want to acquire an image or a video that satisfies a particular condition for entertainment.

Currently, in a common text-to-image model, after some simple text prompts are inputted, the model may automatically generate photographs or videos that conform to these prompts. However, independent training is required for each different portrait, and the training takes a long time. In addition, post-processing fine-tuning is required to maintain consistency of the portrait.

Therefore, because the foregoing independent training and post-processing fine-tuning needs to consume time, which results in a relatively long overall generation time for a target image. Therefore, to improve generation efficiency of a target image is an urgent problem to be solved.

### SUMMARY

Embodiments of this application provide an image generation method and apparatus, an electronic device, a storage medium, and a program product, to improve generation efficiency of a target image.

In one aspect, some embodiments consistent with the present disclosure provide an image generation method, which is performed by an electronic device and includes receiving a first source image of a predetermined style and a second source image comprising a predetermined portrait; performing feature extraction on the first source image using at least one image encoder to obtain at least one image feature; performing facial recognition on the second source image using a facial recognition model to obtain a facial feature of the predetermined portrait; concatenating the at least one image feature with the facial feature to obtain a concatenated feature; and inputting the concatenated feature into a trained diffusion model to generate a target image that is in the predetermined style and that comprises the predetermined portrait.

In another aspect, some embodiments consistent with the present disclosure provide an electronic device, which includes a processor and a memory. The memory has a computer program stored therein, and the processor executes the computer program, to cause the processor to perform the operations of the foregoing image generation method.

In another aspect, some embodiments consistent with the present disclosure provide a non-transitory computer-readable storage medium, which includes a computer program. When being run on an electronic device, the computer program causes the electronic device to perform the operations of the foregoing image generation method.

### BRIEF DESCRIPTION OF THE DRAWINGS

The accompanying drawings described herein are used to provide a further understanding of this application, and form part of this application. Embodiments of this application and descriptions thereof are used to explain this application, and do not constitute any inappropriate limitation on this application. In the accompanying drawings:

FIG. 1 is a schematic diagram of an application scenario according to an embodiment of this application.

FIG. 2 is a flowchart of an embodiment of an image generation method according to an embodiment of this application.

FIG. 3 is a schematic diagram of a first source image and a second source image according to an embodiment of this application.

FIG. 4 is a schematic diagram of a reference image according to an embodiment of this application.

FIG. 5 is a logic block diagram of an image generation process according to an embodiment of this application.

FIG. 6 is a logic block diagram of an image generation process according to an embodiment of this application.

FIG. 7 is a logic block diagram of an image generation process according to an embodiment of this application.

FIG. 8 is a schematic diagram of a process of training a diffusion model according to an embodiment of this application.

FIG. 9 is a schematic diagram of portrait face swapping according to an embodiment of this application.

FIG. 10A is a schematic diagram of a first type of portrait stylization according to an embodiment of this application.

FIG. 10B is a schematic diagram of a second type of portrait stylization according to an embodiment of this application.

FIG. 10C is a schematic diagram of a third type of portrait stylization according to an embodiment of this application.

FIG. 11A is a schematic diagram of a first type of portrait identity (ID) fusion according to an embodiment of this application.

FIG. 11B is a schematic diagram of a second type of portrait ID fusion according to an embodiment of this application.

FIG. 11C is a schematic diagram of a third type of portrait ID fusion according to an embodiment of this application.

FIG. 12A is a schematic diagram of a generation result of a style A according to an embodiment of this application.

FIG. 12B is a schematic diagram of a generation result of another style A according to an embodiment of this application.

FIG. 13 is a schematic diagram of an interaction logic between a terminal device and a server according to an embodiment of this application.

FIG. 14 is a schematic structural diagram of a composition of an image generation apparatus according to an embodiment of this application.

FIG. 15 is a schematic structural diagram of a hardware composition of an electronic device to which an embodiment of this application is applied.

FIG. 16 is a schematic structural diagram of a hardware composition of another electronic device to which an embodiment of this application is applied.

### DESCRIPTION OF EMBODIMENTS

To make the objectives, technical solutions, and advantages of some embodiments consistent with the present disclosure clearer, the technical solutions of this application will be clearly and completely described below with reference to the accompanying drawings in some embodiments consistent with the present disclosure. Apparently, the described embodiments are merely some not all of the embodiments of the technical solutions of this application. Based on the embodiments recorded in this application document, all other embodiments obtained by those of ordinary skill in the art without making creative efforts fall within the scope of protection of the technical solutions of this application.

The following describes some concepts involved in some embodiments consistent with the present disclosure.

Facial alignment: because portraits are photographed at different angles, the photographed portraits are not all facing the front, and a facial alignment process includes: a standard frontal face position is defined in advance, then a transformation matrix between the photographed portrait and the defined standard frontal face position is searched for, and the photographed portrait is normalized to the same shape as the standard frontal face position through translation, rotation, and scaling operations. In addition, the facial alignment operation may be performed in reverse, that is, the aligned face may be restored to an original photographed face state through an inverse transformation matrix.

Portrait identity (ID): each person has his/her own unique facial features. The portrait ID herein is configured for identifying features of each face, including shapes, features, and the like of facial landmarks.

Arcface: it is an open-source facial recognition model taking an image subjected to facial alignment as an input and code of a facial image as an output.

Image style: it refers to a style to which content included in an image belongs, and may be any specific style, including but not limited to any style in a real-world scene and any style in a virtual scene. In some embodiments consistent with the present disclosure, the style of the image refers to a style of a portrait in the image, and may be specifically classified into two types: a photorealistic portrait style and a non-photorealistic portrait style. Further, the photorealistic portrait style or the non-photorealistic portrait style may be further specifically subdivided. For example, the photorealistic portrait style may be further divided into a studio portrait, a campus student photograph, an official photograph, an identification photograph, and the like. For example, the non-photorealistic portrait style may be further divided into animation, two-dimensional art, and the like. This is not specifically limited in this application.

Diffusion model: it is a generation model, and its underlying intuition stems from physics. In physics, diffusion of a gas module from an area with a high concentration to an area with a low concentration is similar to information loss due to interference from noise. Therefore, an image is generated by introducing noise and then denoising. By performing iteration for a plurality of times in a period of time, the model learns to generate a new image each time given some noise inputs.

Here, the terms such as “first” and “second” are used only for the purpose of description, and are not understood as explicitly or implicitly indicating relative importance or implicitly indicating the quantity of the indicated technical features. Therefore, a feature defined to be “first” or “second” may explicitly or implicitly include one or more features. In the description of some embodiments consistent with the present disclosure, unless otherwise specified, “plurality of” means two or more.

Some embodiments consistent with the present disclosure relate to artificial intelligence (AI) and machine learning (ML) technologies, and are specifically designed based on ML in AI.

The AI technology includes both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision technology, a natural language processing technology, and ML/deep learning.

ML is the core of AI, is a basic way to make a computer intelligent. Deep learning is a core of ML, and is a technology for implementing ML. ML generally includes technologies such as deep learning, reinforcement learning, transfer learning, and inductive learning. Deep learning includes technologies such as a mobile visual neural network (MobileNet), a convolutional neural network (CNN), a deep confidence network, a recursive neural network, an autoencoder, and a generative adversarial network.

An image generation method provided in some embodiments consistent with the present disclosure may be implemented by an image generation model obtained through ML training.

The following briefly introduces design ideas of some embodiments consistent with the present disclosure.

Due to different cultures and social backgrounds, people may modify existing photos and videos, or generate target images directly based on text descriptions, to reflect their aesthetics and values. This trend leads to certain developments in AI painting technologies. The main idea is inputting simple text prompts into a text-to-image model, to automatically generate photographs or videos that conform to these prompts. These text prompts include various elements such as a scene, a color, and an object.

Often, a text-to-image model leverages more than one piece of data associated with a specific portrait ID to fine-tune the model, whereby the model has a capability of generating a single portrait ID. However, these solutions require independent training for each different portrait ID, and the training is also time-consuming. In addition, maintaining consistency of the portrait ID requires post-processing fine-tuning using a plurality of pieces of data of the same subject or the portrait ID.

In view of this, some embodiments consistent with the present disclosure propose an image generation method and apparatus, an electronic device, a storage medium, and a program product. In this application, before a target image is generated, feature extraction is performed on a first source image and a second source image, respectively. Specifically, a global feature is extracted from the first source image through an image encoder, and the obtained image feature may retain an original style of the first source image. A facial feature is extracted from the second source image through a facial recognition model, and the obtained facial feature may retain shapes and features of facial landmarks of a predetermined portrait in the second source image. Based on the foregoing obtained features, the image feature is concatenated with the facial feature, and an obtained concatenated feature can include both style information of the first source image and facial information of the second source image. In addition, in this application, a diffusion model is taken as a backbone network for image generation. Based on the concatenated feature as an input of the diffusion model, an image including the predetermined portrait that belongs to the predetermined style may be directly obtained. Accordingly, the predetermined portrait is generated without the need of performing post-processing fine-tuning on the predetermined portrait. In addition, for different predetermined portraits, facial features may be extracted based on the same processing manner, whereby consistency of a portrait ID is maintained, and independent training does not need to be performed for different portraits IDs, whereby generation efficiency of a target image is effectively improved.

The following describes the embodiments of this application with reference to the accompanying drawings of the description. The embodiments described herein are merely intended to describe and explain this application, but are not intended to limit this application. In addition, some embodiments consistent with the present disclosure and features in the embodiments may be mutually combined without conflict.

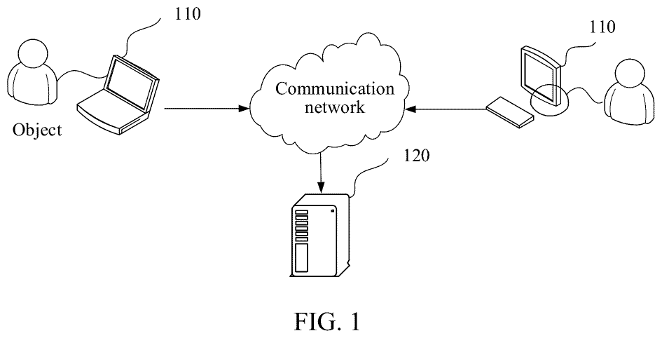

FIG. 1 is a schematic diagram of an application scenario according to an embodiment of this application. The application scenario diagram includes two terminal devices 110 and one server 120.

In some embodiments consistent with the present disclosure, the terminal device 110 includes, but is not limited to, devices such as a mobile phone, a tablet computer, a notebook computer, a desktop computer, an e-book reader, a smart voice interaction device, a smart home appliance, and an on-board terminal. An image generation-related client may be installed on the terminal device. The client may be software (such as a browser or AI drawing software), a web page, a mini program, or the like. The server 120 is a backend server corresponding to the software, the web page, the mini program, or the like, or a server dedicated to performing image generation. This is not specifically limited in this application. The server 120 may be an independent physical server, or may be a server cluster or distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and AI platform.

In addition, the image generation method provided in various embodiments of this application may be performed by an electronic device. The electronic device may be the terminal device 110 or the server 120. That is, the method may be performed by the terminal device 110 alone or the server 120 alone, or may be jointly performed by the terminal device 110 and the server 120.

For example, when the method is jointly performed by the terminal device 110 and the server 120, an image generation-related client may be installed on the terminal device 110. A user may select or upload a first source image belonging to a predetermined style and a second source image including a predetermined portrait through the client. Then, the client transmits the first source image and the second source image to the server 120 through the terminal device 110. An image encoder, a facial recognition model, and a diffusion model are deployed on the server 120.

Specifically, the server 120 performs feature extraction on the first source image through at least one image encoder, to obtain at least one image feature; performs facial recognition on the second source image through the facial recognition model, to obtain a facial feature of the predetermined portrait; concatenates the at least one image feature with the facial feature, to obtain a concatenated feature; and inputs the concatenated feature into the trained diffusion model, to obtain a target image that is generated by the diffusion model taking the concatenated feature as an input, the target image being an image that is obtained by fusing the second source image and the first source image and that includes the predetermined portrait belonging to the predetermined style. Finally, the server 120 may return the obtained target image to the terminal device 110, and the terminal device 110 displays the obtained target image to the user through the client.

In one embodiment, the terminal device 110 may communicate with the server 120 over a communication network.

In one embodiment, the communication network is a wired network or a wireless network.

In addition, FIG. 1 is merely an example for description. Actually, a quantity of terminal devices and a quantity of servers are not limited, and are not specifically limited in some embodiments consistent with the present disclosure.

In some embodiments consistent with the present disclosure, when a plurality of servers are provided, the plurality of servers may form a blockchain, and the servers are nodes on the blockchain. According to the image generation method disclosed in some embodiments consistent with the present disclosure, image data involved in the image generation method may be stored in the blockchain, such as the first source image, the second source image, the image feature, the facial feature, the concatenated feature, and the target image.

In addition, some embodiments consistent with the present disclosure may be applied to various scenarios, including but not limited to scenarios such as cloud technology, AI, intelligent transportation, and driver assistance.

The following describes the image generation method provided in the embodiments of this application with reference to the application scenario described above and the accompanying drawings. The above application scenario is only illustrated to facilitate understanding of the spirit and principles of this application, and the implementations of this application are not limited to the above application scenario.

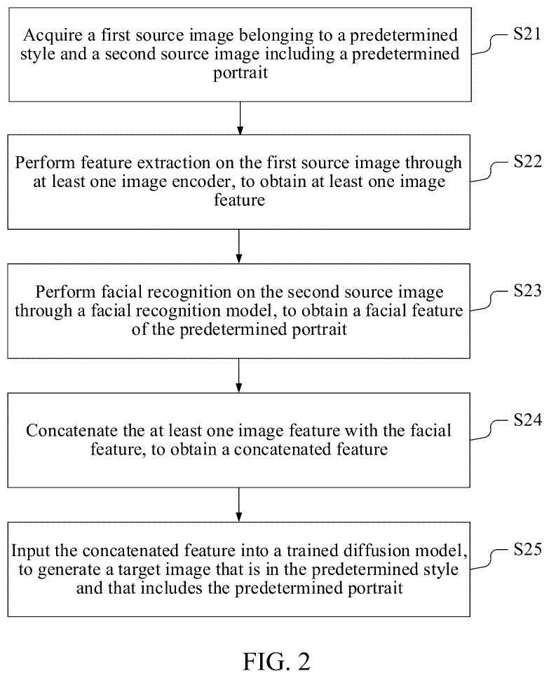

FIG. 2 is a flowchart of an embodiment of an image generation method according to an embodiment of this application. The method is performed by an electronic device, which is, for example, the server 120 in FIG. 1. A specific process of the method is as follows:

S21: Acquire a first source image belonging to a predetermined style and a second source image including a predetermined portrait.

In some embodiments consistent with the present disclosure, the predetermined style may refer to a particular portrait style that is determined in advance, which includes, but is not limited to, any portrait style in a real-world scene (a realistic portrait style such as a studio portrait, a campus student photograph, an official photograph, or an identification photograph), or any portrait style in a virtual scene (a non-realistic portrait style such as animation or two-dimensional art). This is not specifically limited in this application.

The first source image is an image belonging to the predetermined style, and the image also includes a portrait, that is, includes a portrait belonging to the predetermined style. Specifically, the portrait belonging to c. The second source image is an image including the predetermined portrait. As above, the predetermined portrait also includes at least one face.

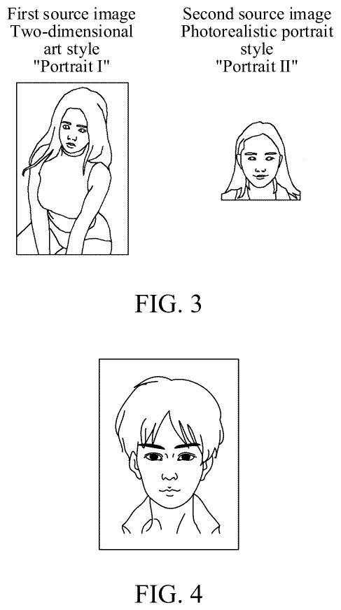

FIG. 3 is a schematic diagram of a first source image and a second source image according to an embodiment of this application. The first source image is an image in a two-dimensional art style, which includes a non-photorealistic portrait, and may be denoted as “portrait I”. The second source image is an image in a photorealistic portrait style, which includes a photorealistic portrait (such as an identification photograph), and may be denoted as “portrait II”.

In some embodiments consistent with the present disclosure, sizes of the first source image and the second source image are not specifically limited, and may be the same or may be different. Similarly, the size of a finally obtained target image is not specifically limited, and may be the same as or different from that of the first source image (for example, may be any preset fixed size).

Based on the image generation method provided in some embodiments consistent with the present disclosure, a generated target image may retain the two-dimensional art style of the first source image, and the “portrait II” may be fused, to generate an image of the “portrait II” in the two-dimensional art style.

When the style of the first source image is consistent with the style of the second source image, for example, both are photorealistic portrait styles, based on the image generation method provided in some embodiments consistent with the present disclosure, face swapping may be performed on the portrait in the second source image based on the portrait in the first source image.

S22: Perform feature extraction on the first source image through at least one image encoder, to obtain at least one image feature.

In some embodiments consistent with the present disclosure, the image encoder may be of any type and any structure, as long as the image encoder can extract an image feature. The image feature is also referred to as an image embedding feature. The at least one obtained image feature corresponds to the predetermined style, and specifically, may correspond to a plurality of attribute dimensions in the predetermined style.

In this operation, when image features are extracted through a plurality of image encoders, the plurality of image encoders may be a plurality of different image encoders.

In one embodiment, the different image encoders are image encoders of the same type and of different degrees of precision, or the different image encoders are image encoders of different types.

In some embodiments consistent with the present disclosure, the type of the image encoder is determined according to a backbone network corresponding to the image encoder. For example, image encoders having the same backbone network may be classified into the same type. Alternatively, the image encoders are divided according to attribute dimensions that the image encoders focus on when learning the image features. Image encoders having the same attribute dimension (such as a shape or a color) may be classified into the same type.

A Contrast Language-Image Pre-training (CLIP)-based image encoder is taken as an example, image embedding features may be extracted through one or more CLIP-based image encoders. The CLIP-based image encoder herein may be an open-source model such as ViT-L/14, RN101, and ViT-B/32. Backbone networks of ViT-L/14 and ViT-B/32 are both ViT and belong to a ViT type, and therefore, ViT-L/14 and ViT-B/32 may be understood as image encoders of the same type and of different degrees of precision. A backbone network of the RN101 is RN and belongs to an RN type, and thereof, RN and ViT-L/14 or ViT-B/32 are image encoders of different types.

In addition, precision of image encoders of the same type refers to a difference between an output value and a true value of the encoder, and is affected by a number of network layers, a network parameter, and the like. This is not specifically limited in this application.

An implementation of operation S22 is as follows: feature extraction is respectively performed on the first source image through a plurality of different image encoders, to obtain an image feature outputted by each image encoder.

For example, image features are extracted through three image encoders, and the three image encoders are respectively denoted as a CLIP-based image encoder 1 (such as ViT-L/14), a CLIP-based image encoder 2 (such as ViT-B/32), and a CLIP image encoder 3 (such as RN101).

Image features respectively outputted by the three image encoders are: a CLIP image embedding feature 1 that is 512-dimensional and is denoted as CE1; a CLIP image embedding feature 2 that is 512-dimensional and is denoted as CE2; and a CLIP image embedding feature 3 that is 768-dimensional and is denoted as CE3.

In some embodiments consistent with the present disclosure, image features are respectively extracted from the same first source image through different image encoders, and the image features may be learned from a plurality of aspects and a plurality of dimensions. Because different image encoders may learn different image features from different attribute dimensions, accuracy of image feature extraction can be improved.

S23: Perform facial recognition on the second source image through a facial recognition model, to obtain a facial feature of the predetermined portrait.

In some embodiments consistent with the present disclosure, the facial recognition model may be of any type and any structure, as long as the facial recognition model can extract facial features.

In some embodiments consistent with the present disclosure, one or more second source images may be provided. The following describes different cases.

Case I: when only one second source image is provided, the facial feature extraction is performed on the second source image through the facial recognition model.

Considering that because portraits are photographed at different angles, the photographed portraits are not all facing the front, before facial feature extraction is performed, the second source image may be pre-processed, to ensure accuracy of facial recognition. One embodiment is as follows:
facial alignment may be performed on the second source image based on a reference image. A face in the reference image is at a preset standard position.

In some embodiments consistent with the present disclosure, the reference image may be a user-defined standard frontal face image, or may be the first source image. This is not specifically limited in this application. The preset standard position refers to that the face is centered in the image and shown facing forward.

FIG. 4 is a schematic diagram of a reference image according to an embodiment of this application. The reference image is a standard frontal face image, and the face is centrally shown in the image. Performing facial alignment based on the reference image may ensure that the aligned second source images uniformly face towards the front. Portraits photographed at various angles are corrected, which improves accuracy of facial recognition for the aligned second source image.

When facial recognition is performed based on facial alignment, a facial feature is extracted, through the facial recognition model, from the second source image subjected to facial alignment.

In this application, the facial recognition model is an Arcface network. That is, facial recognition is performed on an obtained facial alignment result through the Arcface network, to extract a facial feature, which is denoted as a facial embedding feature. For example, the facial embedding feature is 512-dimensional and is denoted as FE.

In the foregoing embodiment, one facial image (that is, the second source image) is freely inputted for extraction and face ID feature mixing, and an image of a predetermined portrait in any style may be generated. The process is simple in operation and is convenient to implement, and can effectively maintain consistency of a portrait ID.

Case II: when a plurality of second source images are provided, facial recognition needs to be respectively performed on each second source image through the facial recognition model, to obtain a facial feature corresponding to each second source image.

In one embodiment, different second source images are images including different predetermined portraits; or different second source images are different images including the same predetermined portrait.

That is, the second source images may include the same portrait ID, that is, may be different images of the same person. For example, the second source images include the same portrait. Specifically, shooting angles, facial expressions, and the like of the portraits may be different. For example, three second source images are provided and all include a “portrait II”. The “portrait II” in one second source image is a frontal face with a smiling expression. The “portrait II” in one second source image is a side face with a smiling expression. The “portrait II” in one second source image is a frontal face with a laughing expression.

Alternatively, the second source images may include different portrait IDs, that is, may be images of different people. That is, portraits in the second source images are different. For example, three second source images are provided. One second source image includes a “portrait II”, one second source image includes a “portrait III”, and one second source image includes a “portrait IV”.

In the foregoing implementation, because the second source image may be selected by a user as needed, one or more second source images may be provided. When a plurality of second source images are provided, the second source images may be images of the same person, or may be images of different people, or some second source images may be images of the same person and some second source images may be images of different people, or the like. Because of the characteristic, one or more facial images may be freely inputted according to the requirements of the user. When a plurality of facial images are inputted, portrait ID features may be extracted and mixed, to generate a portrait image having a mixed ID feature.

In addition, the first source image in some embodiments consistent with the present disclosure may be in any style. Therefore, according to the image generation method in some embodiments consistent with the present disclosure, a feature other than the facial feature may be replaced with an image feature in any other style, whereby the model has a capability of combining (any style+a target face), to generate an image that is in any style and that has any portrait ID (including a mixed ID).

Similar to case I, before facial feature extraction is performed on the plurality of second source images, to ensure accuracy of facial recognition, facial alignment may also be performed on the second source images.

Then, facial recognition is performed on an obtained facial alignment result through an Arcface network, to extract a facial feature, which is denoted as an FE feature. It is assumed that n second source images are provided. FE features respectively corresponding to the n second source images may be respectively denoted as FE1, FE2, FE3, . . . , FEn, n is greater than or equal to 2, and n is a positive integer.

S24: Concatenate the at least one image feature with the facial feature, to obtain a concatenated feature.

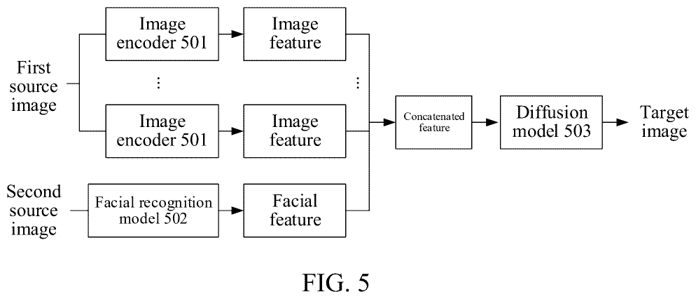

FIG. 5 is a logic block diagram of an image generation process according to an embodiment of this application. A model involved in the process may be collectively referred to as an image generation model. The image generation model includes at least one image encoder 501, a facial recognition model 502, and a diffusion model 503. Each image encoder 501 may perform feature extraction on a first source image once, to obtain one image feature. The facial recognition model 502 may perform feature extraction on a second source image once, to obtain one facial feature. Then, the obtained image feature is concatenated with the facial feature to obtain a concatenated feature. The concatenated feature is taken as an input of the diffusion model 503, to generate an image that is in a predetermined style and that includes a predetermined portrait.

In one embodiment, when image features are extracted through a plurality of image encoders in S22, during feature concatenation in S24, a plurality of image features are directly concatenated with the facial feature.

In one embodiment, when image embedding features are extracted from the first source image through three image encoders, and a facial feature is extracted from one second source image through an Arcface network, a specific manner for implementing S24 is as follows:
a plurality of obtained image features CE (which may alternatively be one) are directly concatenated with a facial feature FE, and a concatenation result is mapped according to a dimension of a preset size, to obtain a concatenated feature.

The dimension of the preset size may be flexibly set according to an actual requirement, and may be a dimension of a two-dimensional matrix of any size. This is not specifically limited in this application.

In some embodiments consistent with the present disclosure, considering that structures of the plurality of image encoders may be different, dimensions of correspondingly obtained image features may also be different. In addition, the facial feature and the image feature are extracted through different models, and dimensions of the image feature and the facial feature may be the same or may be different. CE1 and CE2 listed above are both 512-dimensional, CE3 is 768-dimensional, and FE is 512-dimensional. Therefore, during acquisition of the concatenated feature, the obtained image feature is first concatenated with the facial features, and then a concatenation result is mapped according to a dimension of a preset size, to obtain the concatenated feature.

A description is made by using an example in which the dimension of the preset size is (8, 768). First, a concatenation (concat) operation is performed on CE1, CE2, CE3, and FE to achieve concatenation. A corresponding concatenation result may be denoted as concat (CE1, CE2, CE3, FE), with a dimension of (1, 2304), namely, a vector with a length of 2304. Then, the concatenation result may be mapped once through a linear layer (linear network layer), to map the dimension of the concatenation result from (1, 2304) to (8, 768), namely, 8×768, which represents a matrix having 8 rows and 768 columns and may be denoted as linear (concat (CE1, CE2, CE3, FE)), namely, the concatenated feature in some embodiments consistent with the present disclosure.

During subsequent generation of a target image, the concatenated feature may be taken as an input of the diffusion model for subsequent denoising, to generate the target image that is in the predetermined style and that includes the predetermined portrait.

In another implementation, when image embedding features are extracted from the first source image through three image encoders, and facial features are extracted from n second source images through an Arcface network, a specific manner for implementing S24 is as follows:
first, feature fusion is performed on the plurality of obtained facial features, to obtain a fused facial feature; and then, the at least one image feature is concatenated with the fused facial feature, and a concatenation result is mapped according to a dimension of a preset size, to obtain a concatenated feature.

That is, in a case of a plurality of second source images, instead of directly concatenating each image feature with the plurality of facial features, the facial features respectively corresponding to the plurality of second source images are first fused, and then the fused facial feature is concatenated with the image features, to ensure that a finally generated target image is a result of fusing the predetermined portraits in the plurality of second source images are fused.

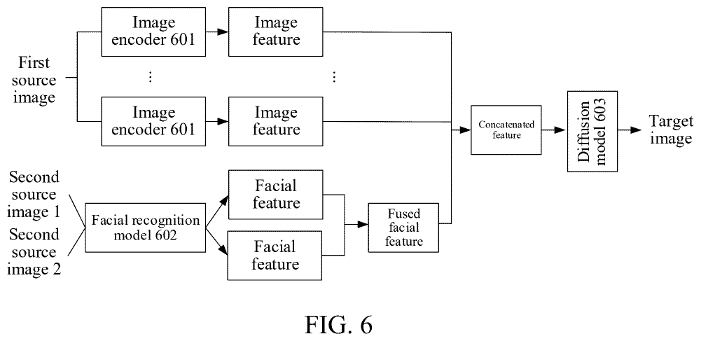

FIG. 6 is a logic block diagram of an image generation process according to an embodiment of this application. An image generation model includes at least one image encoder 601, a facial recognition model 602, and a diffusion model 603. Each image encoder 601 may perform feature extraction on a first source image once, to obtain one image feature. The facial recognition model 602 may perform feature extraction on a second source image once, to obtain one facial feature. When a plurality of second source images are provided, as shown in FIG. 6, two second source images are provided: a second source image 1 and the second source image 2. Facial features first need to be extracted from the second source image through the facial recognition model 602, and the two extracted facial features are fused, to obtain a fused facial feature. Then, the obtained image features are concatenated with the fused facial features to obtain a concatenated feature, and the concatenated feature is taken as an input of the diffusion model 603, to generate an image that is in a predetermined style and that includes a fusion result of a plurality of predetermined portraits.

During feature fusion of the plurality of obtained facial features, an implementation is as follows:
weighted summation is performed on the plurality of facial features, to obtain a fused facial feature. A sum of weights corresponding to different facial features is a fixed value, and the weights corresponding to different facial features are positively correlated with portrait similarities. The portrait similarity is a similarity between a corresponding predetermined portrait and an expected generation result of a target image.

In some embodiments consistent with the present disclosure, the expected generation result of the target image refers to an expected image that a user (that is, a demand side of image generation) wants to obtain. The expected image includes a fused portrait obtained by fusing predetermined portraits in the plurality of second source images. The portrait similarity refers to a similarity between the predetermined portrait and the fused portrait.

Specifically, during feature concatenation, (FE1, FE2, FE3, . . . , FEn) are first fused. n different weights may be given in the fusion process, which are denoted as wᵢ, and a fusion result is denoted as:

$$\overline{FE} = {w}_{i} {FE}_{i} ( i = 1 , 2 , … , n ) \\ {w}_{i} + {w}_{2} + … + {w}_{n} = 1 , {w}_{i} ∈ ( 0 , 1 ) \qquad ( 1 )$$

where F̅E̅ is the fused facial feature, wᵢ∈(0, 1), and a sum of the n weights is a fixed value. As shown in the foregoing formula, the fixed value is 1.

Then, obtained image features CE are concatenated with the fused facial feature F̅E̅, a concatenation result is mapped according to a dimension of a preset size, to obtain a concatenated feature.

A description is made by using an example in which image features are extracted through three image encoders. A specific manner is as follows: first, a concatenation result of CE and the fused facial feature F̅E̅, which is as follows:

$$concat ( {CE}_{1} , {CE}_{2} , {CE}_{3} , \overline{FE} ) \qquad ( 2 )$$

Then, the concatenation result may be mapped once through a linear layer (linear network layer), to map a dimension of the concatenation result from (1, 2304) dimension to (8. 768), that is, obtain a matrix having 8 rows and 768 columns, namely, the concatenated feature in some embodiments consistent with the present disclosure, which may be denoted as:

$$linear ( concat ( {CE}_{1} , {CE}_{2} , {CE}_{3} , \overline{FE} ) ) \qquad ( 3 )$$

A description is made by using an example in which two second source images are provided, one includes a person A, and the other one includes a person B. When a fused facial feature is calculated, w₁ may be determined according to a portrait similarity between the person A and a fused portrait in an expected image, and w₂ is determined according to a portrait similarity between the person B and the fused portrait in the expected image. For example, the expected image is a target image that integrates the person A and the person B and that belongs to style C. In addition, the similarity between the fused portrait in the expected image and the person A is high, and the similarity between the fused portrait and the person B is low.

When feature fusion is performed on a plurality of facial features, a weight w₁ corresponding to a facial feature of the person A may be set larger, a weight w₂ corresponding to a facial feature of the person B is set smaller, and a sum of the two weights is a fixed value (such as 1). For example, wi is set to 0.7, and w₂ is set to 0.3.

Alternatively, in a case that the portrait similarity is not considered, the weights may be set to be the same. A description is made by using an example in which the sum of the weights is a fixed value of 1, each of the n weights is 1/n.

In the foregoing implementation, the portrait similarity is determined according to the fused portrait in the expected image, whereby the weight used during calculation of the fused facial feature can accurately represent a predetermined portrait similarity between the second source image and the target image. Therefore, accuracy of fusion of a plurality of facial features, and during mixing of facial ID features, a target image with a mixed ID feature may be efficiently and accurately generated.

In addition, in some embodiments consistent with the present disclosure, if the predetermined portrait included in the second source image is at the standard position in the image, that is, the second source image is consistent with the reference image, facial alignment process may be not performed.

S25: Input the concatenated feature into a trained diffusion model, to generate a target image that is in the predetermined style and that includes the predetermined portrait.

The target image is obtained by fusing the second source image and the first source image, and is an image that belongs to the predetermined style and that includes the predetermined portrait. In a case of a plurality of second source images, the predetermined portrait that is in the predetermined style and that is included in the target image is a portrait result of fusing predetermined portraits included in the plurality of second source images. In some embodiments consistent with the present disclosure, the trained diffusion model is configured to generate, based on an inputted feature, another similar image with the feature.

In some embodiments consistent with the present disclosure, when the target image is generated through the trained diffusion model, the concatenated feature (which may be understood as a feature map) is taken as an input and denoised, to generate the target image.

Specifically, the trained diffusion model includes a first decoder and a second decoder. The first decoder takes the concatenated feature as an input, and denoises the concatenated feature for a plurality of times, to obtain a denoised feature. Then, the denoised feature is inputted into the second decoder, and the denoised feature is decoded to obtain the target image.

An implementation is as follows: S25 may be performed according to the following flowchart, which includes operation S251 and operation S252 (not shown in FIG. 2):

S251: Denoise the concatenated feature through a first decoder in the diffusion model for a plurality of times, to obtain a denoised feature.

Herein, the noise subtracted by the first decoder is predicted by the trained diffusion model. A denoising result obtained each time of denoising is an input feature inputted into the first decoder next time.

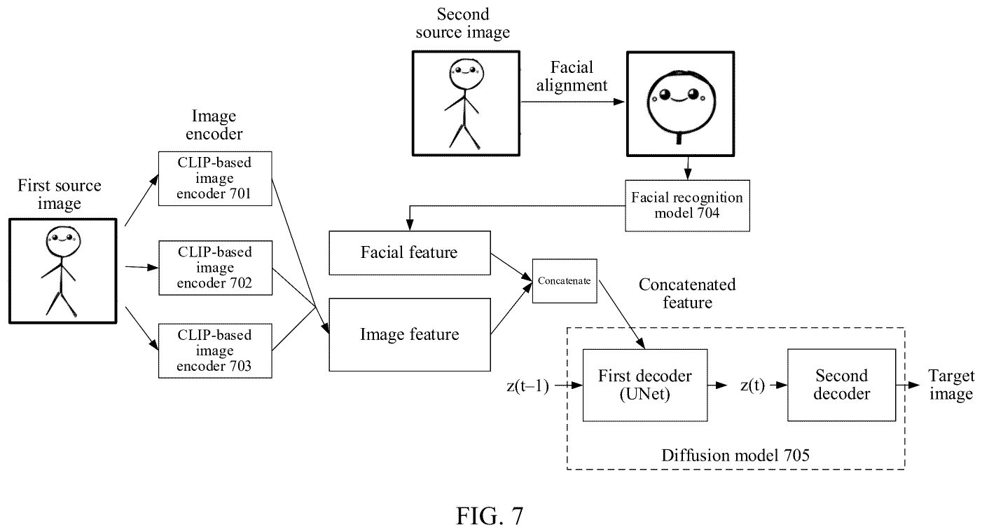

FIG. 7 is a schematic structural diagram of an image generation model according to an embodiment of this application. The image generation model includes three image encoders, such as a CLIP-based image encoder 701, a CLIP-based image encoder 702, and a CLIP-based image encoder 703 (such as RN101) shown in FIG. 7; a facial recognition model 704, such as Arcface; and a diffusion model 705. Specifically, the diffusion model 705 includes a first decoder and a second decoder. The first decoder is a UNet decoder shown in FIG. 7, and may be configured to form a denoising network. The second decoder is configured to form an autoencoder network, such as a decoder in a variational autoencoder (VAE). In some embodiments consistent with the present disclosure, UNet is part of the diffusion model, and is configured to denoise an image. Specifically, a denoising process in UNet needs to be iterated for T times. As shown in FIG. 7, z(t-1) is a feature before each iteration, and z(t) is a feature after each iteration. That is, z(t) is a single iteration result of iterative denoising of z(t-1), and subsequently, z(t) is taken as new z(t-1) in a next iteration and denoised to obtain new z (t).

Specifically, in this application, in the first iterative denoising process, an input of the first decoder is the concatenated feature, that is, z(t-1) is the concatenated feature.

Case I is taken as an example, when only one second source image is provided, z(t-1)=linear(concat(CE1, CE2, CE3, FE)).

Case II is taken as an example, when a plurality of second source images are provided, z(t-1)=linear(concat(CE1, CE2, CE3, FE)).

In addition, a number of times of iterative denoising in S251 may be any positive integer greater than 1. This is not specifically limited in this application. Generally, 20 to 50 iterations are performed.

A description is made by using an example in which denoising is performed 20 times. After the concatenated feature is denoised through the first decoder for 20 times, an output of the first decoder may be denoted as the denoised feature. Then, spatial transformation is performed on the denoised feature through the second decoder.

S252: Input the denoised feature into a second decoder in the diffusion model, restore the denoised feature to an original pixel space through the second decoder, and decode to obtain the target image.

Specifically, the foregoing denoising process is implemented in a latent representation space. That is, the denoised feature is obtained by performing iterative denoising in the latent representation space, and then the denoised feature is restored from the latent representation space to the original pixel space through the second decoder, and is decoded to obtain a complete image.

The foregoing trained diffusion model can predict noise in the concatenated feature, and then denoising is performed through the first decoder. The entire process implements a function of “noise diffusion”, whereby the generated target image has relatively good diversity and reality.

In some embodiments consistent with the present disclosure, when the diffusion model is trained, the concatenated feature taken as an input is a noisy feature, and then the noisy feature is continuously denoised through the first decoder and restored through the second decoder, to generate the target image.

In one embodiment, a manner of adding the noise may be randomly adding Gaussian noise through a diffusion process. The process may be a fixed Markov chain process.

By continuously adding Gaussian noise, an original data distribution is transformed into a normal distribution. Then, when iterative denoising is performed through the first decoder, the Gaussian noise is transformed into content of a known data distribution. For example, the data is restored from the normal distribution to the original data distribution through a neural network.

In an embodiment, the diffusion model is trained in the following manner:
cyclic iterative training is performed on a pre-trained diffusion model based on a training sample set, to obtain the trained diffusion model. Training samples in the training sample set include: at least one sample image feature corresponding to a first sample image and a sample facial feature corresponding to a second sample image including a sample portrait. Different first sample images belong to at least one sample style.

During construction of the training sample set, a batch of portrait data may be collected, which does not need to be paired. For example, approximately 100,000 pieces of data are collected. The portrait data may be further processed in advance. For example, facial alignment is performed on the batch of portrait data in advance, which facilitates use of the portrait data in early model training.

In some embodiments consistent with the present disclosure, the first sample image and the second sample image are both images including portrait data, and may be specifically the foregoing images subjected to facial alignment. In addition, in some embodiments consistent with the present disclosure, the first sample images may belong to the same sample style, or may belong to different sample styles.

When the first sample images belong to the same sample style, the trained diffusion model may better generate an image in the sample style. When the first sample images belong to different sample styles, the trained diffusion model may better generate an image in any one of the sample styles. Herein, “better” means that the diffusion model can better maintain a style feature of the first sample image when generating an image.

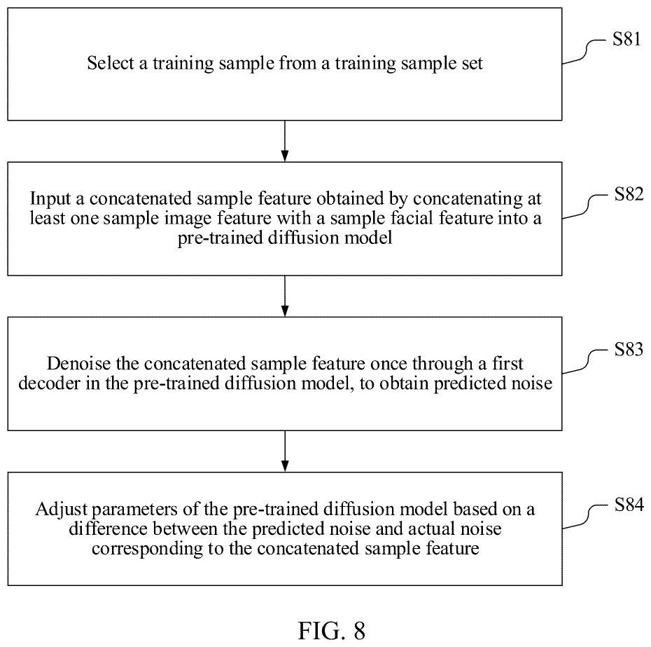

Specifically, in each iterative training, the following operations are performed. FIG. 8 is a schematic diagram of a process of training a diffusion model according to an embodiment of this application. A description is made by using an example in which a server is an execution body, and the training process includes operation S81 to operation S84:

S81: Select a training sample from a training sample set.

S82: Input a concatenated sample feature obtained by concatenating at least one sample image feature with a sample facial feature into a pre-trained diffusion model.

In some embodiments consistent with the present disclosure, fine tuning is mainly performed on decoder-related parameters of the diffusion model. Therefore, the pre-trained diffusion model may be a diffusion model obtained through random initialization, or may be a diffusion model obtained through particular training. In this application, the model is mainly fine-tuned based on facial data in the model training phase (namely, an early phase).

S83: Denoise the concatenated sample feature once through a first decoder in the pre-trained diffusion model, to obtain predicted noise.

A difference from a practical application process of the foregoing model lies in that denoising in the training phase is performed in one iteration, while in an inference phase (also referred to as a practical application phase), namely, operation S251, denoising is typically performed in 20 to 50 iterations.

S84: Adjust parameters of the pre-trained diffusion model based on a difference between the predicted noise and actual noise corresponding to the concatenated sample feature.

The actual noise refers to noise actually added to a feature map corresponding to the concatenated sample feature. The noise may be Gaussian noise added randomly, which follows a normal distribution.

Specifically, the specific implementation of acquiring the sample image feature and the sample facial feature in S82 is the same as the foregoing specific manner of acquiring the image feature and the facial feature. The manner of concatenating the at least one sample image feature with the sample facial feature to obtain the concatenated sample feature is the same as the foregoing manner of concatenating the at least one image feature with the facial feature to obtain the concatenated feature. For details, refer to the foregoing embodiments. Details are not described herein again.

Based on the foregoing description, the obtained concatenated sample feature may be taken as z(t-1), and then z(t-1) is outputted to the diffusion model, and is taken as an input to generate an image including the predetermined portrait. In the training process of the diffusion model, added noise is predicted through diffusion and sampling, and loss comparison with truly added noise is performed to continuously optimize the diffusion model iteratively.

In the training phase, a noise predictor is trained, and an input of each iteration essentially follows a normal distribution.

In the training process, a noisy image and a number of iterations of training t are inputted, and noise e is predicted through the model. A training target is to make an error between the predicted noise and an actually added noise as small as possible.

In conclusion, in this application, during fine-tuning of the model, the feature of the portrait data is taken as an input of the diffusion model to generate a portrait, whereby the model is guided to gradually master a portrait generation method. For the diffusion model, after the model is fine-tuned based on a particular amount of facial data in the training phase, the model may generate a portrait, in any style, of a target ID without the need of being fine-tuned again in the inference phase. The diffusion model that is fine-tuned by the training method has capabilities of comprehending an ID and maintaining consistency. The target image may be directly generated through the trained diffusion model, without the need of post-processing fine-tuning, which effectively improves generation efficiency of the target image.

In some embodiments consistent with the present disclosure, after the model is trained, in the inference phase, referring to logic shown in FIG. 7, a portrait that corresponds to a specified ID and that is in a style to which the model belongs may be generated, and only one style image (namely, a first source image belonging to a predetermined style) and another portrait image (namely, a second source image including a predetermined portrait) need to be provided as inputs.

The image generation method provided in some embodiments consistent with the present disclosure may be applied to, but is not limited to, portrait face swapping, multi-ID portrait fusion and generation (portrait ID fusion for short), and combination and generation (portrait stylization generation for short) of a predetermined portrait in any style (including a non-real-person type).

The following briefly describes the image generation method provided in some embodiments consistent with the present disclosure mainly in several scenarios: portrait face swapping, portrait stylization generation, and portrait ID fusion:

### (I) Portrait Face Swapping

In a scenario of portrait face swapping, a feature of a predetermined portrait may be combined with a feature of another portrait, to transform the predetermined portrait based on the another portrait.

In this scenario, a first source image includes the another portrait, and a second source image includes the predetermined portrait. Through face swapping, an identity feature of the predetermined portrait in the second source image may be migrated to the first source image, to obtain a target image after face swapping. Accordingly, the obtained target image not only maintains the identity feature of the second source image, but also has an attribute feature of the first source image, such as a posture, an expression, lighting, and a background.

In an embodiment, when the first source image includes a reference portrait, and the first source image and the second source image both belong to the predetermined style, the target image is: an image obtained by transforming the predetermined portrait based on the reference portrait.

That is, when three-dimensional styles of the first source image and the second source image are consistent, for example, are photorealistic portrait styles, based on the image generation method provided in some embodiments consistent with the present disclosure, face swapping may be implemented for the portrait in the second source image based on the portrait in the first source image.

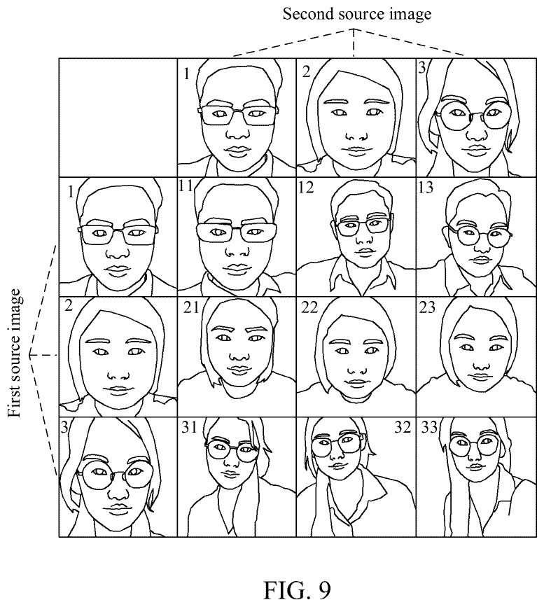

FIG. 9 is a schematic diagram of portrait face swapping according to an embodiment of this application. Images X (X=1, 2, or 3) show examples of results obtained after face swapping is performed on any two of three portraits numbered 1, 2, and 3. An image numbered 11 represents an example of a face swapping result (that is, a target image) obtained in a case that an image numbered 1 is taken as both a first source image and a second source image. Similarly, an image numbered 12 represents an example of a face swapping result obtained in a case that the image numbered 1 is taken as the first source image and an image numbered 2 is taken as the second source image. An image numbered 13 represents an example of a face swapping result obtained in a case that the image numbered 1 is taken as the first source image and an image numbered 3 is taken as the second source image. An image numbered 21 represents an example of a face swapping result obtained in a case that the image numbered 2 is taken as the first source image and the image numbered 1 is taken as the second source image; . . . ; and so forth.

Specifically, face swapping may be applied to the fields of content generation, film production, entertainment video production, and the like. This is not specifically limited in this application.

In some embodiments consistent with the present disclosure, the feature of the predetermined portrait may be combined with a feature of the reference portrait, to transform the predetermined portrait into the reference portrait. The image generation method is applied to the fields of content generation, film production, and entertainment video production, which improves interaction between a user and an image, a video, and the like.

### (II) Portrait Stylization Generation

In a scenario of portrait stylization generation, a predetermined portrait may be combined with any particular style image, to generate an image that includes the predetermined portrait and that is in a particular style. In addition, in this process, predetermined portraits may be combined in any manner, to generate an image integrating different predetermined portraits ID features.

In this scenario, the first source image is any particular style image. The style image mainly reflects a style of an image, and may not include a portrait. The predetermined portrait included in a second source image may be any portrait ID.

A description is made below by using an example in which the first source image is a two-dimensional art style image. Examples of target images corresponding to different second source images are respectively listed below.

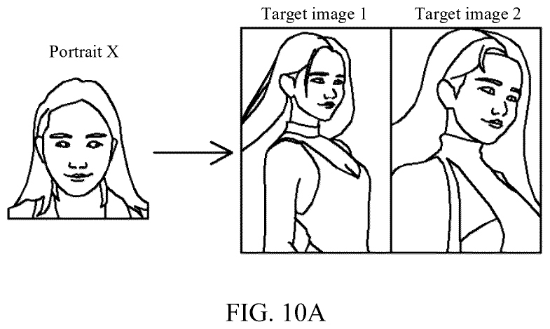

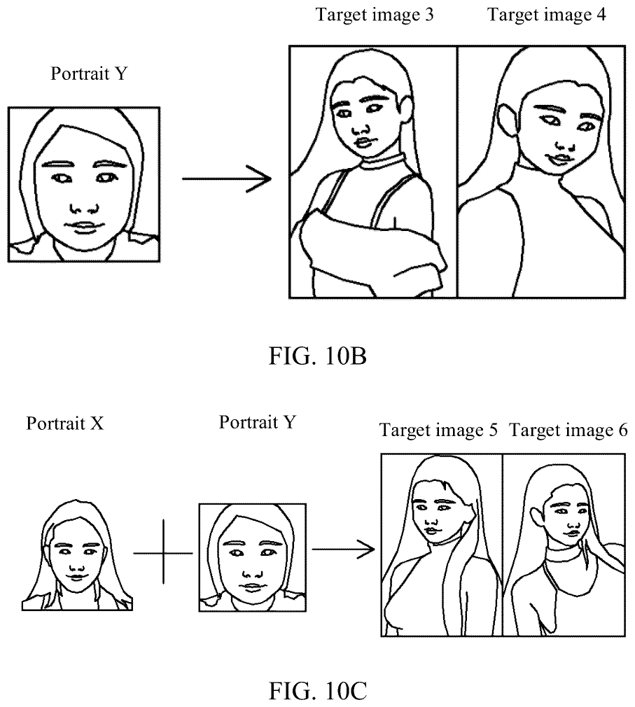

FIG. 10A is a schematic diagram of a first type of portrait stylization generation according to an embodiment of this application. FIG. 10A shows examples of two types of target images that are generated when an image including a portrait X is taken as the second source image. For example, a target image 1 and a target image 2 in FIG. 10A are portrait images that include the person X and that are in the two-dimensional art style.

FIG. 10B is a schematic diagram of a second type of portrait stylization generation according to an embodiment of this application. FIG. 10B shows examples of two types of target images that are generated when an image including a portrait Y is taken as the second source image. For example, a target image 3 and a target image 4 in FIG. 10B are portrait images that include the person Y and that are in the two-dimensional art style.

Specifically, in the foregoing two cases, during generation of the target images, different target images may be generated due to different quantities of image encoders, different quantities of denoising, and the like.

FIG. 10C is a schematic diagram of a third type of portrait stylization generation according to an embodiment of this application. FIG. 10C shows examples of two types of target images that are generated when an image including a portrait X and an image including a portrait Y are taken as second source images (that is, two second source images are provided). For example, a target image 5 and a target image 6 in FIG. 10C are fused portrait images that fuse the person X and the person Y and that are in the two-dimensional art style.

Specifically, in this case, during generation of the target images, different target images may be generated due to different quantities of image encoders, different quantities of denoising, different setting of weights during calculation of a fused person feature, and the like.

### (III) Portrait ID Fusion

In a scenario of portrait ID fusion, a predetermined portrait may be combined with a portrait image in any style. The portrait image in any style herein may further be a non-real photorealistic portrait type.

In this scenario, the first source image is the portrait image in any style, and a second source image includes the predetermined portrait.

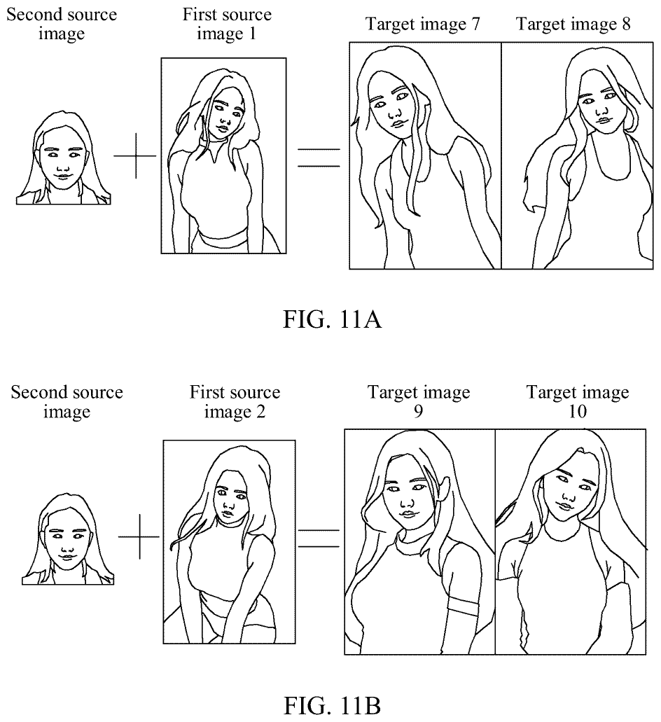

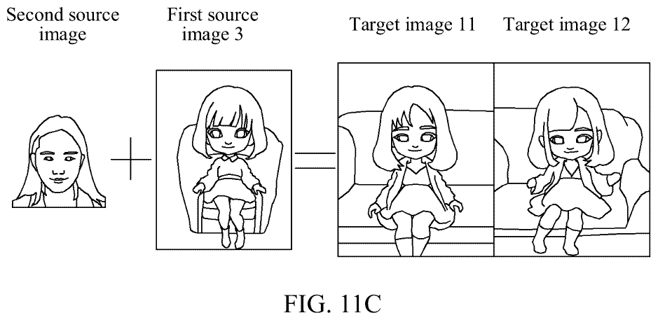

FIG. 11A to FIG. 11C are schematic diagrams of three types of portrait ID fusion according to embodiments of this application. The three figures respectively show examples of target images generated when the same second source image and different first source images are adopted.

FIG. 11A shows a target image generated based on a first source image 1. FIG. 11B shows a target image generated based on a first source image 2.FIG. 11C shows a target image generated based on a first source image 3.

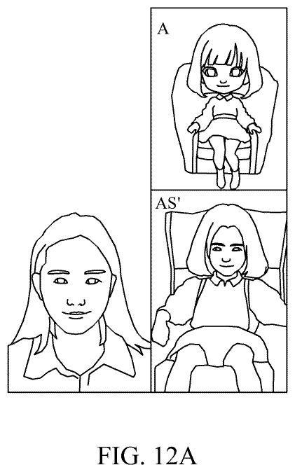

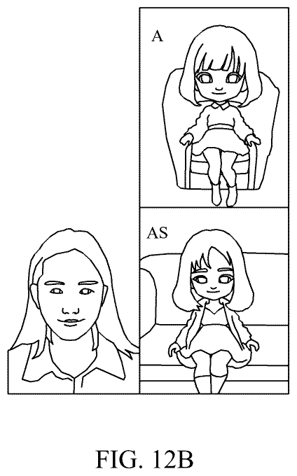

Specifically, generation of target images in different styles is described above. However, when the image generation model is specifically trained, it is assumed that a desired style is A, and an effect that corresponds to the style A and that is generated by the image generation model is AS′, which is, as shown in FIG. 12A, significantly different from an effect of A. A batch of data in the style A may be collected or generated in batches, and the image generation model is fine-tuned by the foregoing model training method. Approximately 1000 pieces of data in the style A are provided for fine-tuning herein, and the image generation model is trained with 500 to 1000 iterations on an 8-GPU machine, whereby the model has a generation capability for the style A. Accordingly, a photorealistic result AS of the style A may be generated, as shown in FIG. 12B, which is basically consistent with the style A with little deviation.

Similarly, if a model capable of generating a photorealistic target image in a style B is desired, a batch of data in the style B may be collected or generated in batches, and the model is fine-tuned by the foregoing model training method. If a model capable of generating both a photorealistic target image in the style A and a photorealistic target image in the style B is desired, sample data needs to include both data in the style A and data in the style B. This is not specifically limited in this application.

In addition, only simple descriptions are provided above for the several scenarios: portrait face swapping, portrait stylization generation, and portrait ID fusion. In addition, the image generation method provided in some embodiments consistent with the present disclosure is further applicable to any other image generation scenario. This is not specifically limited in this application.

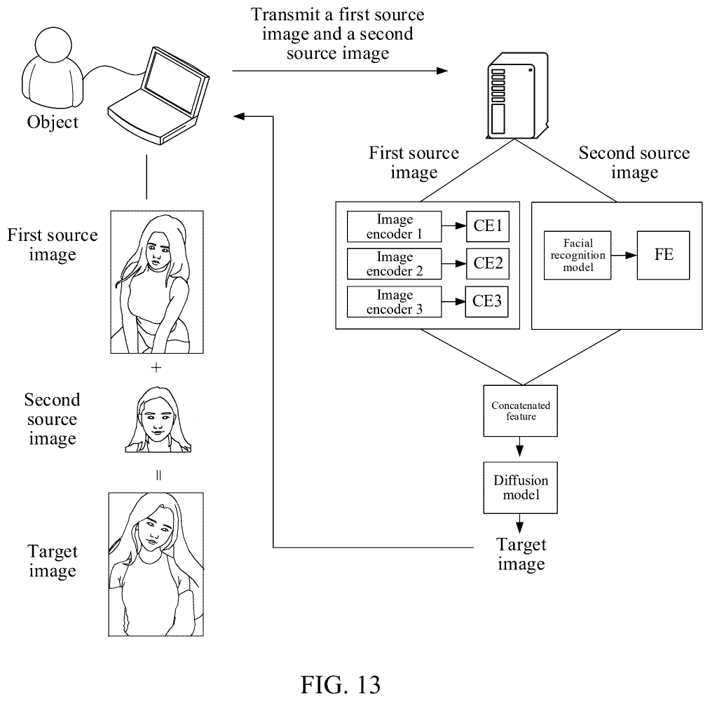

FIG. 13 is a schematic diagram of an interaction logic between a terminal device and a server according to an embodiment of this application.

First, a user may select or upload, through a client installed on the terminal device, a first source image belonging to a predetermined style and a second source image including a predetermined portrait.

Then, the client transmits the first source image and the second source image to the server through the terminal device.

An image encoder, a facial recognition model, and a diffusion model are deployed on the server. Specifically, the server performs feature extraction on the first source image through three image encoders, such as an image encoder 1, an image encoder 2, and an image encoder 3 in FIG. 13, to obtain corresponding image features, such as CE1, CE2, and CE3 in FIG. 13; performs facial recognition on the second source image through the facial recognition model, to obtain a facial feature FE of the predetermined portrait; concatenates CE1, CE2, CE3, and FE, to obtain a concatenated feature; and inputs the concatenated feature into a trained diffusion model, to obtain a target image that is generated by the diffusion model taking the concatenated feature as an input.

Finally, the server may return the obtained target image to the terminal device, and the terminal device displays the obtained target image to the user through the client.

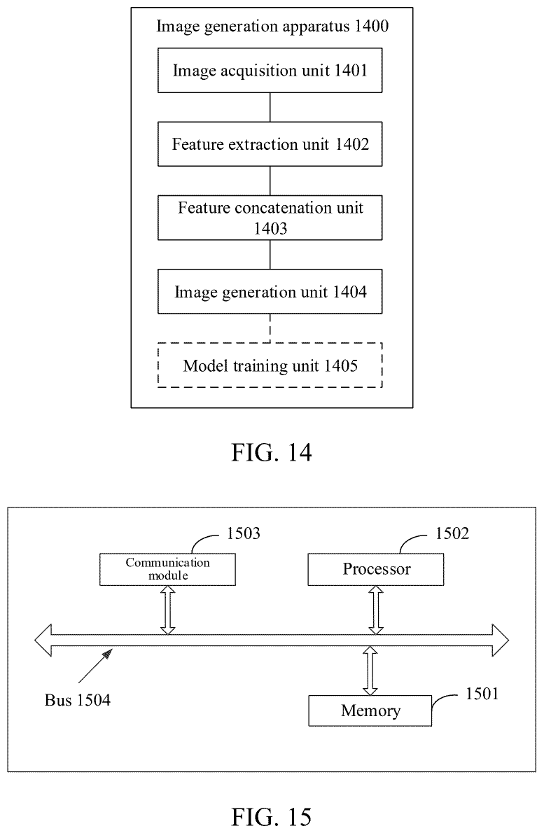

Based on the same inventive concept, some embodiments consistent with the present disclosure further provide an image generation apparatus. FIG. 14 is a schematic structural diagram of an image generation apparatus 1400, which may include:
an image acquisition unit 1401, configured to acquire a first source image belonging to a predetermined style and a second source image including a predetermined portrait; a
feature extraction unit 1402, configured to perform feature extraction on the first source image through at least one image encoder, to obtain at least one image feature; and perform facial recognition on the second source image through a facial recognition model, to obtain a facial feature of the predetermined portrait;
a feature concatenation unit 1403, configured to concatenate the at least one image feature with the facial feature, to obtain a concatenated feature; and
an image generation unit 1404, configured to input the concatenated feature into a trained diffusion model, to generate a target image that is in the predetermined style and that includes the predetermined portrait.

In an embodiment, when a plurality of second source images are provided, the feature extraction unit 1402 is specifically configured to:
respectively perform facial recognition on the second source images through the facial recognition model, to obtain a facial feature corresponding to each second source image.

The feature concatenation unit 1403 is specifically configured to:
perform feature fusion on the plurality of obtained facial features, to obtain a fused facial feature; and
concatenate the at least one image feature with the fused facial feature, and map a concatenation result according to a dimension of a preset size, to obtain the concatenated feature.

In an embodiment, different second source images are images including different predetermined portraits; or different second source images are different images including the same predetermined portrait.

In an embodiment, the feature concatenation unit 1403 is specifically configured to:
perform weighted summation on the plurality of facial features, to obtain the fused facial feature.

Weights corresponding to different facial features are positively correlated with portrait similarities. The portrait similarity is a similarity between a predetermined portrait included in each second source image and an expected image, and the expected image includes a fused portrait obtained by fusing predetermined portraits in the plurality of second source images.

In an embodiment, the feature extraction unit 1402 is further configured to:
perform facial alignment on the second source image based on a reference image before performing facial recognition on the second source image through the facial recognition model, to obtain the facial feature, a face in the reference image being at a preset standard position.

In an embodiment, the feature extraction unit 1402 is specifically configured to:
respectively perform feature extraction on the first source image through a plurality of different image encoders, to obtain an image feature outputted by each image encoder.

The feature concatenation unit 1403 is specifically configured to:
concatenate the plurality of obtained image features with the facial feature, and map a concatenation result according to a dimension of a preset size, to obtain the concatenated feature.

In an embodiment, the different image encoders are image encoders of the same type and of different degrees of precision, or the different image encoders are image encoders of different types.

In an embodiment, the trained diffusion model includes a first decoder and a second decoder, and the image generation unit 1404 is specifically configured to:
denoise the concatenated feature through the first decoder for a plurality of times, to obtain a denoised feature, a denoising result obtained each time of denoising being an input feature inputted into the first decoder next time; and
input the denoised feature into the second decoder, restore the denoised feature to an original pixel space through the second decoder, and decode to obtain the target image.

In an embodiment, the apparatus further includes a model training unit 1405, configured to train the diffusion model in the following manner:
perform cyclic iterative training on a pre-trained diffusion model based on a training sample set, to obtain the trained diffusion model. Training samples in the training sample set include: at least one sample image feature corresponding to a first sample image and a sample facial feature corresponding to a second sample image including a sample portrait. In each iterative training, the model training unit is configured to:
input a concatenated sample feature obtained by concatenating the at least one sample image feature with the sample facial feature into the pre-trained diffusion model;
denoise the concatenated sample feature once through a first decoder in the pre-trained diffusion model, to obtain predicted noise; and
adjust parameters of the pre-trained diffusion model based on a difference between the predicted noise and noise added to a feature map corresponding to the concatenated sample feature.

In an embodiment, when the first source image includes a reference portrait, and the first source image and the second source image both belong to the predetermined style, the target image is: an image obtained by transforming the predetermined portrait based on the reference portrait.

For ease of description, the foregoing parts are divided into modules (or units) based on functions for respective description. Certainly, during implementation of this application, the functions of the modules (units) may be implemented in the same piece of or a plurality of pieces of software and/or hardware.

After the image generation method and apparatus according to implementations of this application are described, next, an electronic device according to another implementation of this application is described.

A person skilled in the art may understand that the aspects of this application may be implemented as a system, a method, or a program product. Therefore, the aspects of this application may be specifically implemented in the following forms: a pure hardware implementation, a pure software implementation (including firmware, microcode, and the like), or a combined implementation of both hardware and software aspects, which is collectively referred to as a “circuit”, “module”, or “system” herein.

Based on the same inventive concept as the foregoing method embodiments, some embodiments consistent with the present disclosure further provide an electronic device. In an embodiment, the electronic device may be a server, such as the server 120 shown in FIG. 1. In this embodiment, as shown in FIG. 15, a structure of the electronic device may include a memory 1501, a communication module 1503, and one or more processors 1502.

The memory 1501 is configured to store a computer program executed by the processor 1502. The memory 1501 may mainly include a program storage area and a data storage area. The program storage area may store an operating system, a program required to run instant messaging functions, and the like; and the data storage area may store various instant messaging information, an operation instruction set, and the like.

The memory 1501 may be a volatile memory, such as a random-access memory (RAM). Alternatively, the memory 1501 may be a non-volatile memory, such as a read-only memory (ROM), a flash memory, a hard disk drive (HDD), or a solid-state drive (SSD). Alternatively, the memory 1501 is, but is not limited to, any other medium capable of carrying or storing an expected computer program having an instruction or data structural form and being accessed by a computer. The memory 1501 may be a combination of the foregoing memories.

The processor 1502 may include one or more central processing units (CPU), digital processing units, or the like. The processor 1502 is configured to implement the image generation method when calling the computer program stored in the memory 1501.

The communication module 1503 is configured to communicate with a terminal device or another server.

Specific connecting media between the memory 1501, the communication module 1503, and the processor 1502 are not limited in some embodiments consistent with the present disclosure. In some embodiments consistent with the present disclosure, in FIG. 15, the memory 1501 and the processor 1502 are connected through a bus 1504. The bus 1504 is depicted with a thick line in FIG. 15. Connecting manners among other components are merely illustrative and are not intended to be limiting. The bus 1504 may be classified into an address bus, a data bus, a control bus, and the like. For ease of description, the bus is only depicted with the thick line in FIG. 15, but it does not indicate that only one bus or one type of bus exists.

The memory 1501 has a computer storage medium stored therein. The computer storage medium has computer-executable instructions stored therein. The computer-executable instructions are configured for implementing the image generation method provided in some embodiments consistent with the present disclosure. The processor 1502 is configured to perform the image generation method, as shown in FIG. 2.

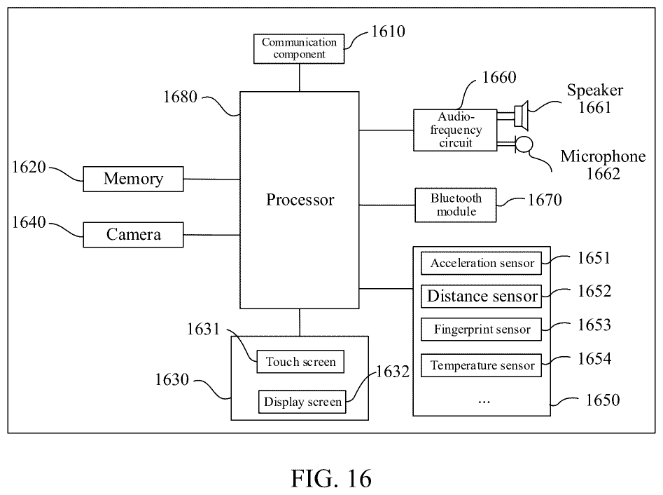

In another embodiment, the electronic device may alternatively be another electronic device, such as the terminal device 110 shown in FIG. 1. In this embodiment, as shown in FIG. 16, a structure of the computer device may include: components such as a communication component 1610, a memory 1620, a display unit 1630, a camera 1640, a sensor 1650, an audio-frequency circuit 1660, a Bluetooth module 1670, and a processor 1680.

The communication module 1610 is configured to communicate with a server. In some embodiments, the structure of the electronic device may further include a wireless fidelity (WiFi) module. The WiFi module is a short distance wireless transmission technology, and the electronic device may help a user transmit and receive information through the WiFi module.

The memory 1620 may be configured to store a software program and data. The processor 1680 executes various functions of the terminal device 110 and processes data by running the software program or data stored in the memory 1620. The memory 1620 may include a high-speed RAM, and may further include a non-volatile memory, such as at least one magnetic disk storage device, a flash memory device, or another volatile solid-state storage device. The memory 1620 stores an operating system causing the terminal device 110 to run. In this application, the memory 1620 may store an operating system and various application programs, and may further store a computer program configured for performing the image generation method provided in some embodiments consistent with the present disclosure.

The display unit 1630 may be further configured to display information inputted by a user or information provided for a user, and a graphical user interface (GUI) of various menus of the terminal device 110. Specifically, the display unit 1630 may include a display screen 1632 disposed on a front surface of the terminal device 110. The display screen 1632 may be configured in the form of liquid crystal display, light-emitting diode, or the like. The display unit 1630 may be configured to display an operation interface of the AI drawing software, the first source image, the second source image, the target image, and the like that are provided in some embodiments consistent with the present disclosure.

The display unit 1630 may be further configured to receive inputted digit or character information, and generate a signal input related to user settings and function control of the terminal device 110. Specifically, the display unit 1630 may include a touch screen 1631 arranged on a front surface of the terminal device 110, and the touch screen may collect a touch operation of a user on or near the touch screen, such as clicking a button and dragging a scroll box.

The touch screen 1631 may be overlaid on the display screen 1632, or the touch screen 1631 and the display screen 1632 may be integrated to implement input and output functions of the terminal device 110, and may be referred to as a touch display screen after integration. In this application, the display unit 1630 may display an application program and corresponding operations.

The camera 1640 may be configured to capture a static image, and the user may publish the image captured by the camera 1640 through an application. One or more cameras 1640 may be provided. An optical image of an object is generated through the lens and is projected to the photosensitive element. The photosensitive element may be a charge-coupled device (CCD) or a complementary metal-oxide-semiconductor (CMOS) phototransistor. The photosensitive element converts an optical signal into an electrical signal and then transfers the electrical signal to the processor 1680 to be converted into a digital image signal.

The terminal device may further include at least one sensor 1650, such as an acceleration sensor 1651, a distance sensor 1652, a fingerprint sensor 1653, and a temperature sensor 1654. The terminal device may be further configured with another sensor such as a gyroscope, a barometer, a hygrometer, a thermometer, an infrared sensor, an optical sensor, or a motion sensor.

The audio-frequency circuit 1660, a speaker 1661, and a microphone 1662 may provide audio interfaces between the user and the terminal device 110. The audio-frequency circuit 1660 may convert received audio data into an electric signal and transmit the electric signal to the speaker 1661. The speaker 1661 converts the electric signal into a sound signal and outputs the sound signal. The terminal device 110 may be further configured with a volume button, which is configured to adjust a volume of the sound signal. Furthermore, the microphone 1662 converts a collected sound signal into an electrical signal. After receiving the electrical signal, the audio-frequency circuit 1660 converts the electrical signal into audio data, and then outputs the audio data to, for example, another terminal divide 110 through the communication component 1610, or outputs the audio data to the memory 1620 for further processing.

The Bluetooth module 1670 is configured to perform information interaction with another Bluetooth device having a Bluetooth module by using a Bluetooth protocol. For example, the terminal device may establish, through the Bluetooth module 1670, a Bluetooth connection with a wearable electronic device (such as a smartwatch) also equipped with a Bluetooth module, to perform data interaction.

The processor 1680 is a control center of the terminal device, and is connected to various parts of the terminal device through various interfaces and lines. By running or executing the software program stored in the memory 1620 and calling the data stored in the memory 1620, the processor performs various functions of the terminal device and processes data. In some embodiments, the processor 1680 may include one or more processing units. An application processor and a baseband processor may be further integrated into the processor 1680. The application processor mainly processes an operating system, a user interface, an application program, and the like, and the baseband processor mainly processes wireless communication. The foregoing baseband processor may either not be integrated into the processor 1680. In this application, the processor 1680 may run the operating system, the application, user interface display, and touch response, and perform the image generation method provided in some embodiments consistent with the present disclosure. In addition, the processor 1680 is coupled to the display unit 1630.

In some possible implementations, the aspects of the image generation method provided in this application may be further implemented in the form of a program product, which includes a computer program. When the program product is run on the electronic device, the computer program is configured to cause the electronic device to perform the operations of the image generation method according to various implementations of this application described above in the description. For example, the electronic device may perform the operations shown in FIG. 2.

The program product may adopt any combination of one or more readable media. The readable medium may be a computer-readable signal medium or a computer-readable storage medium. The readable storage medium may be, for example, but is not limited to, an electric, magnetic, optical, electromagnetic, infrared, or semi-conductive system, apparatus, or device, or any combination thereof. More specific examples (non-exhaustive list) of the readable storage medium include: an electrical connection having one or more conductors, a portable disk, a hard disk, a RAM, a ROM, an erasable programmable ROM (EPROM or a flash memory), an optical fiber, a portable compact disc ROM (CD-ROM), an optical storage device, a magnetic storage device, or any appropriate combination thereof.

The program product provided in the implementations of this application may adopt a portable CD-ROM in combination with a computer program, which may be run on the electronic device. However, the program product of this application is not limited thereto. In this document, the readable storage medium may be any tangible medium including or storing a program, and the program may be used by or used in combination with an instruction execution system, apparatus, or device.

The readable signal medium may include a data signal propagated in a baseband or as a part of a carrier, which carries a readable computer program. A data signal propagated in such a way may assume a plurality of forms, including but not limited to, an electromagnetic signal, an optical signal, or any appropriate combination thereof. The readable storage medium may be further any readable medium other than a readable storage medium, and the readable storage medium may transmit, propagate, or transfer a program used by or in combination with an instruction execution system, apparatus, or device.

The computer program included in the readable medium may be transmitted through any appropriate medium, which includes, but is not limited to, a wireless medium, a wired medium, an optical cable, a radio frequency (RF), or the like, or any appropriate combination thereof.

The computer program configured for executing the operations of this application may be written in any combination of one or more programming languages. The programming languages include an object-oriented programming language such as Java and C++, and further include a conventional procedural programming language such as “C” or a similar programming language. The computer program may be executed entirely on an electronic device of a user, may be executed partially on the electronic device of the user, may be executed as an independent software package, may be executed partially on the electronic device of the user and partially on a remote electronic device, or may be executed entirely on the remote electronic device or a server. In a case involving the remote electronic device, the remote electronic device may be connected to the electronic device of the user through any type of network, which includes a local area network (LAN) or a wide area network (WAN), or may be connected to an external electronic device (for example, connected through the Internet provided by an Internet service provider).

Although several units or subunits of the apparatus are mentioned in the foregoing detailed descriptions, such division is merely exemplary and not mandatory. Actually, according to the implementations of this application, the features and functions of two or more units described above may be embodied in one unit. On the contrary, the feature or function of one unit described above may be further divided and embodied in a plurality of units.

In addition, although the operations of the method of this application are described in a particular order in the drawings, this does not require or imply that the operations need to be performed in the particular order or that all illustrated operations need to be performed to achieve the desired results. Additionally or alternatively, some operations may be omitted, a plurality of operations may be combined into one operation for execution, and/or one operation may be decomposed into a plurality of operations for execution.

A person skilled in the art may understand that some embodiments consistent with the present disclosure may be provided as a method, a system, or a computer program product. Therefore, this application may adopt the form of pure hardware embodiments, pure software embodiments, or combined embodiments of software and hardware. Moreover, this application may adopt the form of a computer program product that is implemented on one or more computer-usable storage media (including but not limited to, a disk memory, a CD-ROM, an optical memory, and the like) including a computer-usable computer program.

This application is described with reference to the flowcharts and/or block diagrams of the method, the device (system), and the computer program product according to some embodiments consistent with the present disclosure. Each process and/or block in the flowcharts and/or block diagrams and a combination of processes and/or blocks in the flowcharts and/or block diagrams may be implemented through computer program instructions. These computer program instructions may be provided to a processor of a general-purpose computer, a special-purpose computer, an embedded processor, or another programmable data processing device to generate a machine, whereby an apparatus configured to implement functions specified in one or more processes in the flowcharts and/or one or more blocks in the block diagrams is generated through the instructions executed by the processor of the computer or another programmable data processing device.

These computer program instructions may alternatively be stored in a computer-readable memory that can instruct a computer or another programmable data processing device to work in a specific manner, whereby the instructions stored in the computer-readable memory generate an artifact that includes an instruction apparatus. The instruction apparatus implements functions specified in one or more processes in the flowcharts and/or in one or more blocks in the block diagrams.

These computer program instructions may alternatively be loaded onto a computer or another programmable data processing device, whereby a series of operations and steps are performed on the computer or the another programmable device, to generate computer-implemented processing. Therefore, the instructions executed on the computer or the another programmable device provide steps for implementing functions specified in one or more processes in the flowcharts and/or in one or more blocks in the block diagrams.

Although embodiments of this application have been described, once a person skilled in the art knows the basic creative concept, he/she can make additional changes and modifications to these embodiments. Therefore, the appended claims are intended to be construed as to cover the embodiments and all changes and modifications falling within the scope of this application.

Apparently, a person skilled in the art may make various modifications and variations to this application without departing from the spirit and scope of this application. In this case, if the modifications and variations made to this application fall within the scope of the claims of this application and equivalent technologies thereof, this application is intended to cover these modifications and variations.

What is claimed is:

1. An image generation method, performed by an electronic device and comprising:
receiving a first source image of a predetermined style and a second source image comprising a predetermined portrait;
performing feature extraction on the first source image using at least one image encoder to obtain at least one image feature;
performing facial recognition on the second source image using a facial recognition model to obtain a facial feature of the predetermined portrait;
concatenating the at least one image feature with the facial feature to obtain a concatenated feature; and
inputting the concatenated feature into a trained diffusion model to generate a target image that is in the predetermined style and that comprises the predetermined portrait.

2. The method according to claim 1, wherein when a plurality of second source images are provided, the performing facial recognition on the second source image using a facial recognition model to obtain a facial feature of the predetermined portrait comprises:
respectively performing facial recognition on the second source images using the facial recognition model to obtain a facial feature corresponding to each second source image; and
the concatenating the at least one image feature with the facial feature to obtain a concatenated feature comprises:
performing feature fusion on the plurality of obtained facial features to obtain a fused facial feature; and
concatenating the at least one image feature with the fused facial feature and mapping a concatenation result according to a dimension of a preset size to obtain the concatenated feature.

3. The method according to claim 2, wherein different second source images are images comprising different predetermined portraits, or are different images comprising the same predetermined portrait.

4. The method according to claim 2, wherein the performing feature fusion on the plurality of obtained facial features to obtain a fused facial feature comprises:
performing weighted summation on the plurality of facial features to obtain the fused facial feature, weights corresponding to different facial features being positively correlated with portrait similarities, portrait similarity being similarity between a predetermined portrait in each second source image and an expected image, and the expected image comprising a fused portrait obtained by fusing predetermined portraits in the plurality of second source images.

5. The method according to claim 1, before the performing facial recognition on the second source image through a facial recognition model to obtain a facial feature of the predetermined portrait, further comprising:
performing facial alignment on the second source image based on a reference image, a face in the reference image being at a preset standard position.

6. The method according to claim 1, wherein the performing feature extraction on the first source image through at least one image encoder to obtain at least one image feature comprises:
respectively performing feature extraction on the first source image using a plurality of different image encoders to obtain an image feature outputted by each image encoder; and
the concatenating the at least one image feature with the facial feature to obtain a concatenated feature comprises:
concatenating the plurality of obtained image features with the facial feature, and mapping a concatenation result according to a dimension of a preset size to obtain the concatenated feature.

7. The method according to claim 6, wherein the different image encoders are image encoders of the same type and of different degrees of precision, or the different image encoders are image encoders of different types.

8. The method according to claim 1, wherein the trained diffusion model comprises a first decoder and a second decoder, and the inputting the concatenated feature into a trained diffusion model to generate a target image that is in the predetermined style and that comprises the predetermined portrait comprises:
denoising the concatenated feature through the first decoder for a plurality of times to obtain a denoised feature, a denoising result obtained each time of denoising being an input feature inputted into the first decoder next time; and
inputting the denoised feature into the second decoder, restoring the denoised feature to an original pixel space using the second decoder, and decoding to obtain the target image.

9. The method according to claim 1, wherein the diffusion model is trained in the following manner:
performing iterative training on a pre-trained diffusion model based on a training sample set to obtain the trained diffusion model;
training samples in the training sample set comprising: at least one sample image feature corresponding to a first sample image and a sample facial feature corresponding to a second sample image comprising a sample portrait; and in each iterative training, performing:
inputting a concatenated sample feature obtained by concatenating the at least one sample image feature with the sample facial feature into the pre-trained diffusion model;
denoising the concatenated sample feature once through a first decoder in the pre-trained diffusion model to obtain predicted noise; and
adjusting parameters of the pre-trained diffusion model based on a difference between the predicted noise and noise added to a feature map corresponding to the concatenated sample feature.

10. The method according to claim 1, wherein when the first source image comprises a reference portrait, and the first source image and the second source image both belong to the predetermined style, the target image is: an image obtained by transforming the predetermined portrait based on the reference portrait.

11. An electronic device, comprising a processor and a memory, the memory having a computer program stored therein, and the processor executing the computer program, to cause the processor to perform an image generation method, comprising:
receiving a first source image of a predetermined style and a second source image comprising a predetermined portrait;
performing feature extraction on the first source image using at least one image encoder to obtain at least one image feature;
performing facial recognition on the second source image using a facial recognition model to obtain a facial feature of the predetermined portrait;
concatenating the at least one image feature with the facial feature to obtain a concatenated feature; and
inputting the concatenated feature into a trained diffusion model to generate a target image that is in the predetermined style and that comprises the predetermined portrait.

12. The electronic device according to claim 11, wherein when a plurality of second source images are provided, the performing facial recognition on the second source image using a facial recognition model to obtain a facial feature of the predetermined portrait comprises:
respectively performing facial recognition on the second source images using the facial recognition model to obtain a facial feature corresponding to each second source image; and
the concatenating the at least one image feature with the facial feature to obtain a concatenated feature comprises:
performing feature fusion on the plurality of obtained facial features to obtain a fused facial feature; and
concatenating the at least one image feature with the fused facial feature and mapping a concatenation result according to a dimension of a preset size to obtain the concatenated feature.

13. The electronic device according to claim 12, wherein different second source images are images comprising different predetermined portraits, or are different images comprising the same predetermined portrait.

14. The electronic device according to claim 12, wherein the performing feature fusion on the plurality of obtained facial features to obtain a fused facial feature comprises:
performing weighted summation on the plurality of facial features to obtain the fused facial feature, weights corresponding to different facial features being positively correlated with portrait similarities, portrait similarity being similarity between a predetermined portrait in each second source image and an expected image, and the expected image comprising a fused portrait obtained by fusing predetermined portraits in the plurality of second source images.

15. The electronic device according to claim 11, before the performing facial recognition on the second source image through a facial recognition model to obtain a facial feature of the predetermined portrait, further comprising:
performing facial alignment on the second source image based on a reference image, a face in the reference image being at a preset standard position.

16. The electronic device according to claim 11, wherein the performing feature extraction on the first source image through at least one image encoder to obtain at least one image feature comprises:
respectively performing feature extraction on the first source image using a plurality of different image encoders to obtain an image feature outputted by each image encoder; and
the concatenating the at least one image feature with the facial feature to obtain a concatenated feature comprises:
concatenating the plurality of obtained image features with the facial feature, and mapping a concatenation result according to a dimension of a preset size to obtain the concatenated feature.

17. The electronic device according to claim 16, wherein the different image encoders are image encoders of the same type and of different degrees of precision, or the different image encoders are image encoders of different types.

18. The electronic device according to claim 11, wherein the trained diffusion model comprises a first decoder and a second decoder, and the inputting the concatenated feature into a trained diffusion model to generate a target image that is in the predetermined style and that comprises the predetermined portrait comprises:
denoising the concatenated feature through the first decoder for a plurality of times to obtain a denoised feature, a denoising result obtained each time of denoising being an input feature inputted into the first decoder next time; and
inputting the denoised feature into the second decoder, restoring the denoised feature to an original pixel space using the second decoder, and decoding to obtain the target image.

19. The electronic device according to claim 11, wherein the diffusion model is trained in the following manner:
performing iterative training on a pre-trained diffusion model based on a training sample set to obtain the trained diffusion model;
training samples in the training sample set comprising: at least one sample image feature corresponding to a first sample image and a sample facial feature corresponding to a second sample image comprising a sample portrait; and in each iterative training, performing:
inputting a concatenated sample feature obtained by concatenating the at least one sample image feature with the sample facial feature into the pre-trained diffusion model;
denoising the concatenated sample feature once through a first decoder in the pre-trained diffusion model to obtain predicted noise; and
adjusting parameters of the pre-trained diffusion model based on a difference between the predicted noise and noise added to a feature map corresponding to the concatenated sample feature.

20. A non-transitory computer-readable storage medium, comprising a computer program, when run on an electronic device, the computer program causing the electronic device to perform an image generation method, comprising:
receiving a first source image of a predetermined style and a second source image comprising a predetermined portrait;
performing feature extraction on the first source image using at least one image encoder to obtain at least one image feature;
performing facial recognition on the second source image using a facial recognition model to obtain a facial feature of the predetermined portrait;
concatenating the at least one image feature with the facial feature to obtain a concatenated feature; and
inputting the concatenated feature into a trained diffusion model to generate a target image that is in the predetermined style and that comprises the predetermined portrait.
